(19) United States
(12) Patent Application Publication
(10) Pub. No.: US 2013/0159150 A1
(43) Pub. Date: Jun. 20, 2013

(54) MOBILE DEVICE DATA METERING, BANDWIDTH ALLOCATION, AND TRAFFIC CONTROL

(71) Applicants: Jack Jianxiu HAO, Lexington, MA (US); Michael R. OLIVER, Wayne, NJ (US); Raul I. ALDREY, Plano, TX (US); Ruchir RODRIGUES, Dallas, TX (US)

(72) Inventors: Jack Jianxiu HAO, Lexington, MA (US); Michael R. OLIVER, Wayne, NJ (US); Raul I. ALDREY, Plano, TX (US); Ruchir RODRIGUES, Dallas, TX (US)

(73) Assignee: VERIZON PATENT AND LICENSING, INC., Basking Ridge, NJ (US)

(21) Appl. No.: 13/330,319

(22) Filed: Dec. 19, 2011

(51) Int. Cl. G06Q 30/00; G06F 15/16

(52) U.S. Cl. 705/30; 709/224

(57) ABSTRACT

A device receives data usage information associated with application server devices and user equipment, and determines time-based prices for data usage based on the data usage information. The time-based prices include at least a first price for data usage during a peak time period, and a second price, less than the first price, for data usage during a non-peak time period. The device also provides the time-based prices for data usage to the application server devices, and the application server devices provide data to the user equipment at different time-based prices depending on a time when the data is provided to the user equipment.

### BACKGROUND

A service provider is an entity (e.g., a business or an organization) that sells access to a network (e.g., the Internet, a data network, a telecommunication network, etc.). Service providers may include telecommunications companies, data carriers, wireless communications providers, Internet service providers, cable television operators offering high-speed Internet access, etc. Service provider networks enable third party application developers to create applications (e.g., via application servers) that use network resources, such as network bandwidth, to provide applications to user equipment (UE). However, network bandwidth provided by a service provider is limited, and increased data traffic between UEs and application servers may cause a network to become congested rather quickly.

### BRIEF DESCRIPTION OF THE DRAWINGS

FIG. 1 is a diagram of an example network in which systems and/or methods described herein may be implemented;

FIG. 2 is a diagram of example components of one or more devices of the network illustrated in FIG. 1;

FIG. 3 is a diagram of example information collection operations capable of being performed by an example portion of the network of FIG. 1;

FIG. 4 is a diagram of example time-based pricing operations capable of being performed by an example portion of the network of FIG. 1;

FIG. 5 is a diagram of example location-based pricing operations capable of being performed by an example portion of the network of FIG. 1;

FIG. 6 is a diagram of example auction-based pricing operations capable of being performed by an example portion of the network of FIG. 1;

FIG. 7 is a diagram of example guaranteed bandwidth operations capable of being performed by an example portion of the network of FIG. 1;

FIG. 8 is a flow chart of an example process for providing time-based and location-based pricing for network bandwidth according to an implementation described herein;

FIG. 9 is a flow chart of an example process for providing auction-based pricing for network bandwidth according to an implementation described herein; and

FIG. 10 is a flow chart of an example process for providing guaranteed network bandwidth according to an implementation described herein.

### DETAILED DESCRIPTION OF PREFERRED EMBODIMENTS

The following detailed description refers to the accompanying drawings. The same reference numbers in different drawings may identify the same or similar elements.

Systems and/or methods described herein may enable a service provider to monitor and meter data service provided by application servers to UEs. The systems and/or methods may enable the service provider to control traffic between the application servers and the UEs by dynamically changing a price charged for data usage by the application servers. In one example, the systems and/or methods may enable the service provider to provide time-based dynamic pricing, location-based dynamic pricing, auction-based dynamic pricing, and/or a guaranteed bandwidth to the application servers. The data usage prices may be charged to the application servers rather than to the users of the UEs.

As used herein, the terms “user” and “customer” may be used interchangeably. Also, the terms “user” and “customer” are intended to be broadly interpreted to include a UE or a user of a UE.

The term “component,” as used herein, is intended to be broadly construed to include hardware (e.g., a processor, a microprocessor, an application-specific integrated circuit (ASIC), a field-programmable gate array (FPGA), a chip, a memory device (e.g., a read only memory (ROM), a random access memory (RAM), etc.), etc.) or a combination of hardware and software (e.g., a processor, microprocessor, ASIC, etc. executing software contained in a memory device).

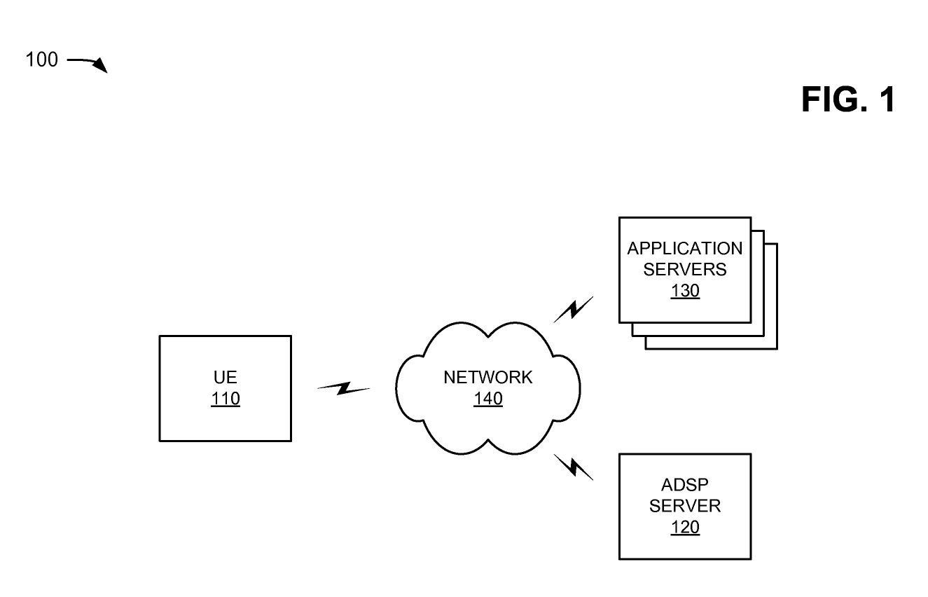

FIG. 1 is a diagram of an example network 100 in which systems and/or methods described herein may be implemented. As illustrated, network 100 may include a user equipment (UE) 110, an advanced data service platform (ADSP) server 120, and one or more application servers 130 interconnected by a network 140. Components of network 100 may interconnect via wired and/or wireless connections or links. One UE 110, one ADSP server 120, multiple application servers 130, and one network 140 have been illustrated in FIG. 1 for simplicity. In practice, there may be more UEs 110, ADSP servers 120, application servers 130, and/or networks 140.

UE 110 may include any device that is capable of communicating with ADSP server 120 and/or application servers 130 via network 140. For example, UE 110 may include a mobile computation and communication device, such as a radiotelephone, a personal communications system (PCS) terminal that may, for example, combine a cellular radiotelephone with data processing and data communications capabilities; a personal digital assistant (PDA) that can include, for example, a radiotelephone, a pager, Internet/intranet access, etc.; a wireless device; a smartphone; a laptop computer; a tablet computer; a global positioning system (GPS) device; etc. Alternatively, or additionally, UE 110 may include a fixed (e.g., provided in a particular location, such as within a user's home) computation and communication device, such as a laptop computer, a personal computer, a set-top box (STB), a television, a gaming system, etc.

ADSP server 120 may include one or more server devices, or other types of computation and communication devices, that gather, process, search, and/or provide information in a manner described herein. In an example implementation, ADSP server 120 may meter data usage of each UE 110 based on application information (e.g., an application identifier (ID)); data connection information (e.g., hypertext transfer protocol (HTTP), real time streaming protocol (RTSP), etc.); data source and destination information (e.g., IP addresses, port numbers, etc.); and other parameters (e.g., user ID, time, location, etc.). ADSP 120 may enable real time control of traffic provided between UEs 110 and application servers 130 through dynamic pricing of data usage rates for bandwidth utilized by UEs 110 and application servers 130.

Application server 130 may include one or more server devices, or other types of computation and communication devices, that gather, process, search, and/or provide information in a manner described herein. In an example implementation, application server 130 may store one or more applications that use resources provided by a service provider network, such as network 140. The applications may include applications that determine locations of mobile communication devices (e.g., UEs 110), applications that connect calls between UE 110 and other UEs 110, voicemail applications, messaging applications, video applications, etc. The applications of application server 130 may provide data (e.g., textual information, video, audio, images, etc.) to users associated with UE 110.

Network 140 may include a local area network (LAN), a wide area network (WAN), a metropolitan area network (MAN), a telephone network, such as the Public Switched Telephone Network (PSTN), an intranet, the Internet, an optical fiber or fiber optic-based network, or a combination of networks. In one example implementation, network 140 may enable UE 110 to communicate with one or more of ADSP server 120 and/or application servers 130.

Although FIG. 1 shows example components of network 100, in other implementations, network 100 may contain fewer components, different components, differently arranged components, or additional components than depicted in FIG. 1. Alternatively, or additionally, one or more of the components of network 100 may perform one or more functions described as being performed by another one or more of the components of network 100.

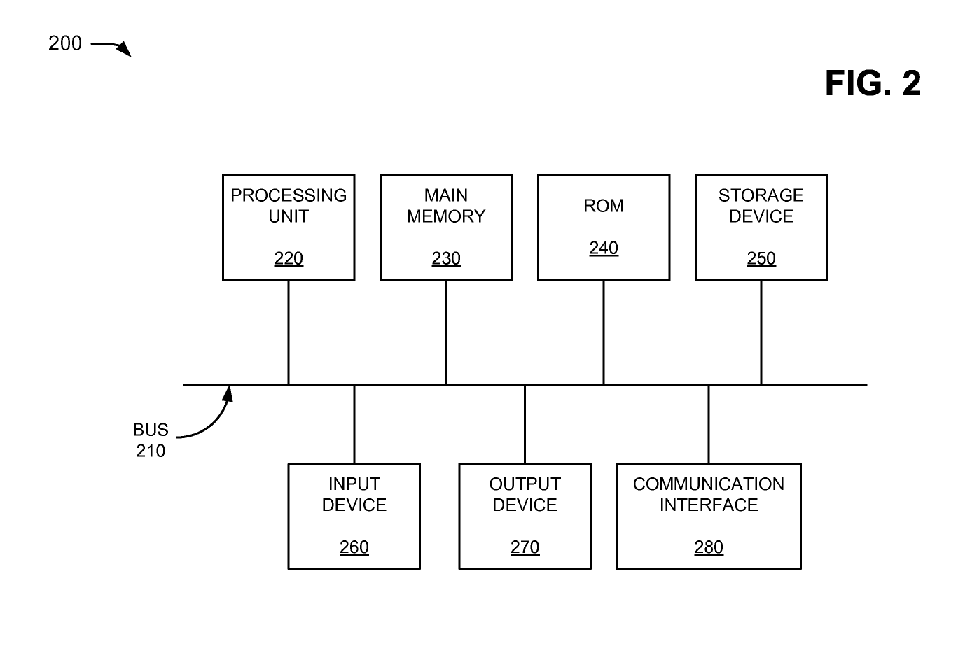

FIG. 2 is a diagram of example components of a device 200 that may correspond to one or more devices of network 100 (FIG. 1). In one example implementation, one or more of the devices of network 100 may include one or more devices 200 or one or more components of device 200. As illustrated, device 200 may include a bus 210, a processing unit 220, a main memory 230, a ROM 240, a storage device 250, an input device 260, an output device 270, and/or a communication interface 280. Bus 210 may include a path that permits communication among the components of device 200.

Processing unit 220 may include one or more processors, microprocessors, or other types of processing units that may interpret and execute instructions. Main memory 230 may include a RAM or another type of dynamic storage device that may store information and instructions for execution by processing unit 220. ROM 240 may include a ROM device or another type of static storage device that may store static information and/or instructions for use by processing unit 220. Storage device 250 may include a magnetic and/or optical recording medium and its corresponding drive.

Input device 260 may include a mechanism that permits an operator to input information to device 200, such as a keyboard, a mouse, a pen, a microphone, voice recognition and/or biometric mechanisms, etc. Output device 270 may include a mechanism that outputs information to the operator, including a display, a printer, a speaker, etc. Communication interface 280 may include any transceiver-like mechanism that enables device 200 to communicate with other devices and/or systems. For example, communication interface 280 may include mechanisms for communicating with another device or system via a network.

As described herein, device 200 may perform certain operations in response to processing unit 220 executing software instructions contained in a computer-readable medium, such as main memory 230. A computer-readable medium may be defined as a non-transitory memory device. A memory device may include space within a single physical memory device or spread across multiple physical memory devices. The software instructions may be read into main memory 230 from another computer-readable medium or from another device via communication interface 280. The software instructions contained in main memory 230 may cause processing unit 220 to perform processes described herein. Alternatively, hardwired circuitry may be used in place of or in combination with software instructions to implement processes described herein. Thus, implementations described herein are not limited to any specific combination of hardware circuitry and software.

Although FIG. 2 shows example components of device 200, in other implementations, device 200 may include fewer components, different components, differently arranged components, or additional components than depicted in FIG. 2. Alternatively, or additionally, one or more components of device 200 may perform one or more other tasks described as being performed by one or more other components of device 200.

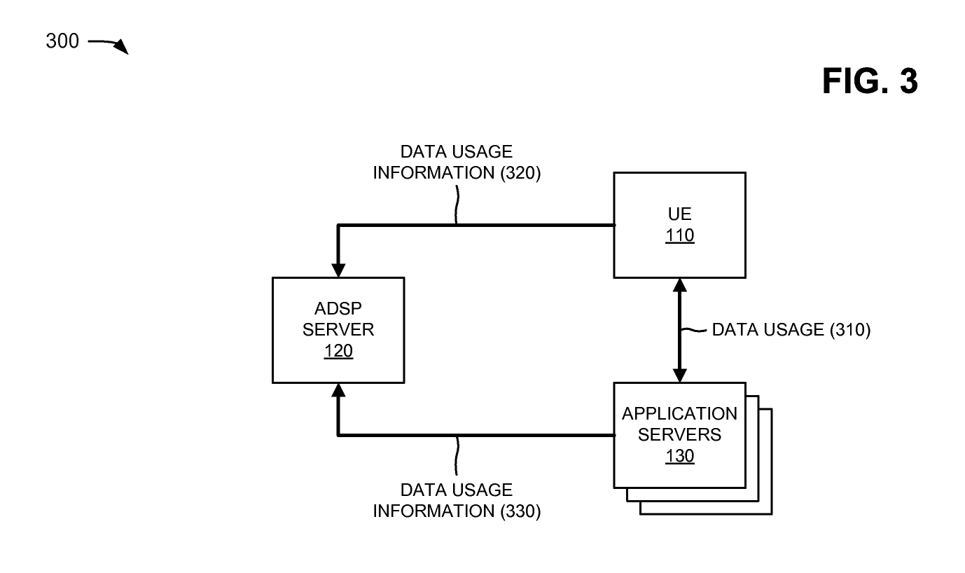

FIG. 3 is a diagram of example information collection operations capable of being performed by an example portion 300 of network 100. As shown in FIG. 3, network portion 300 may include UE 110, ADSP server 120, and application servers 130. UE 110, ADSP server 120, and application servers 130 may include the features described above in connection with one or more of, for example, FIGS. 1 and 2.

As further shown in FIG. 3, UE 110 and application servers 130 may exchange data, as indicated by data usage 310. Data usage 310 may include application servers 130 providing one or more applications to UE 110, UE 110 requesting one or more applications from application servers 130, UE 110 and application servers 130 communicating with one another during execution of applications, etc. In one example implementation, UE 110 may include a mobile client application that, when executed, monitors data usage 310 between UE 110 and application servers 130. The mobile client application of UE 110 may provide, to ADSP server 120, information 320 associated with the monitored data usage 310. Data usage information 320 may include, for example, application IDs, source and destination IP addresses, source and destination port numbers, connection types (e.g., HTTP, RTSP, etc.), etc. associated with data usage 310.

Alternatively, or additionally, application servers 130 may monitor data usage 310 associated with UE 110 and application servers 130. Application servers 130 may provide, to ADSP server 120, information 330 associated with the monitored data usage 310. Data usage information 330 may include, for example, the information provided in the table below.

| | Cell | | | Source | Data call | Usage | Bill | Billing |
|---|---|---|---|---|---|---|---|---|
| Time | Site ID | App ID | Source IP | Port | type | (bytes) | Code | Rate |
| 2011/06/14/ | 95 | 123 | 132.197.76.55 | 80 | HTTP | 750 | 123 | $0.5/kb |
| 13:15:30 | | | | | | | | |
| 2011/06/14/ | 95 | 123 | 132.197.76.56 | 8081 | HTTPS | 500 | 123 | $0.5/kb |
| 14:15:00 | | | | | | | | |
| 2011/06/14/ | 112 | 123 | 132.197.76.55 | 8080 | RTSP | 56000 | 123 | $0.1/kb |
| 21:16:20 | | | | | | | | |
| 2011/06/14/ | 112 | 123 | 132.197.76.55 | 80 | HTTP | 750 | 123 | $0.1/kb |
| 23:15:20 | | | | | | | | |

As shown in the table, data usage information 330 may include a time field. a cell site ID field, an application ID field, a source IP field, a source port field, a data call type field, a usage field, a bill code field, and a billing rate field. The time field may include times associated with data connection initiations between UE 110 and application servers 130. The cell site ID field may include a cell site ID (e.g., of a cell serving UE 110) for location-based pricing, described in more detail below. The application ID field may include application IDs associated with applications provided by application servers 130 to UE 110. The source IP field may include source data connection IP addresses associated with UE 110 and/or application servers 130. The source port field may include ports of source data connections associated with UE 110 and/or application servers 130. The data call type field may include data call type information associated with UE 110 and/or application servers 130. The usage field may include data usage 310 per data connection between UE 110 and application servers 130.

The bill code field may include a billing code defined by a service provider for billing data usage 310 by application servers 130. For example, some data usage 310 may be billed to a user of UE 110, and some data usage 310 may be billed to providers of application servers 130 or to providers of applications hosted by application servers 130. As shown in the table, for example, if the bill code field includes a billing code of “123,” the providers of application servers 130 may be billed for data usage 310. If the bill code field includes a billing code of “1122” (not shown in the table), the user of UE 110 may be billed for data usage 310. The billing rate field may include a billing rate (e.g., in dollars ($) per kilobyte (kb)) for data usage 310 associated with UE 110 and/or application servers 130. In one example implementation, the billing rate may dynamically change based on time, location of UE 110, and/or negotiated rates (e.g., an auction), as described in more detail below.

Although FIG. 3 shows example components of network portion 300, in other implementations, network portion 300 may include fewer components, different components, differently arranged components, or additional components than depicted in FIG. 3. Alternatively, or additionally, one or more components of network portion 300 may perform one or more other tasks described as being performed by one or more other components of network portion 300.

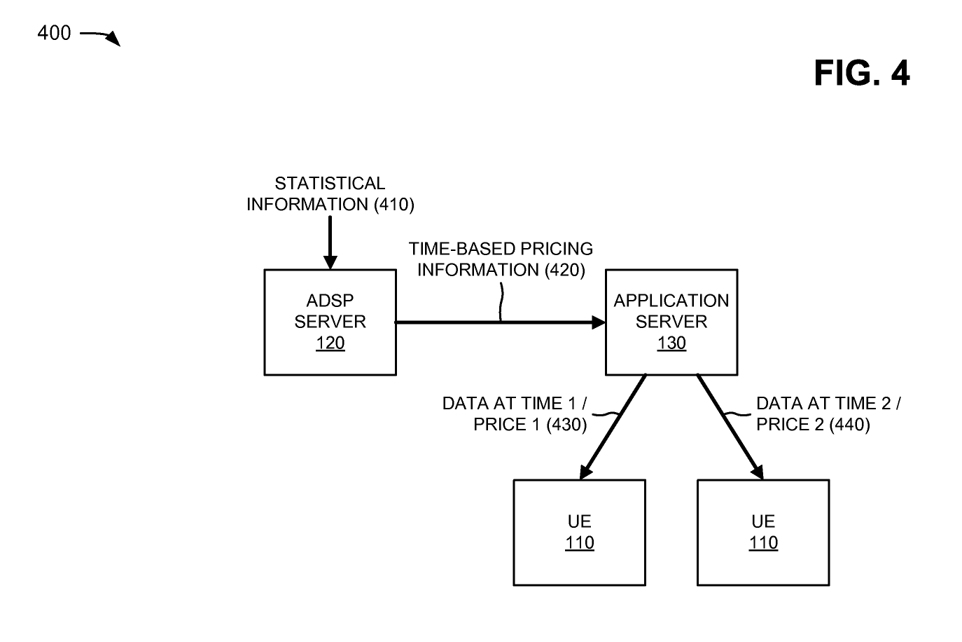

FIG. 4 is a diagram of example time-based pricing operations capable of being performed by an example portion 400 of network 100 (FIG. 1). As shown in FIG. 4, network portion 400 may include two UEs 110, ADSP server 120, and application server 130. UEs 110, ADSP server 120, and application server 130 may include the features described above in connection with one or more of, for example, FIGS. 1-3.

In one example, bandwidth of network 100 (FIG. 1) may be limited. Consequently, ADSP server 120 may allocate traffic (i.e., data usage) within the limited bandwidth so that network 100 does not become congested. In one example implementation, ADSP server 120 may control traffic by dynamically changing a price charged for data usage by different application servers 130. By dynamically changing the price charged for data usage, ADSP server 120 may adjust traffic flows for application servers 130 by using price as a tool. In this example, application providers associated with application servers 130 may be charged for data usage rather than users of UEs 110. The application providers, in turn, may charge the users of UEs 110 for the applications and data usage associated with the applications, or may recoup data usage charges in other ways (e.g., via advertisement revenues).

As shown in FIG. 4, ADSP server 120 may receive statistical information 410, which may include data usage demands by UEs 110 and/or application servers 130 on an hourly basis, a daily basis, a weekly basis, etc. ADSP server 120 may determine time-based pricing information 420 based on the data usage demands provided in statistical information 410. Time-based pricing information 420 may enable ADSP server 120 to control data usage by UEs 110 and application server 130. For example, time-based pricing information 420 may indicate that a first price (e.g., PRICE 1) should be charged during a first time of day (e.g., TIME 1). In one example, the first time of day may be a time associated with peak data usage (e.g., from 9:00 AM to 2:00 PM), and the first price may be a price (e.g., $0.5/kb) that is high enough to discourage users from accessing applications (e.g., downloading large files or watching a movie) from application server 130 during the first time of day.

Time-based pricing information 420 may indicate that a second price (e.g., PRICE 2) should be charged during a second time of day (e.g., TIME 2). In one example, the second time of day may be a time associated with off-peak data usage (e.g., from 11:00 PM to 5:00 AM), and the second price may be a price (e.g., $0.1/kb) that is low enough to encourage users to access applications (e.g., downloading large files or watching a movie) from application server 130 during the second time of day.

As further shown in FIG. 4, ADSP server 120 may provide time-based pricing information 420 to application server 130 in real time, and application server 130 may adjust data usage rates charged to users of UEs 110 in real time. Application server 130 may provide data 430, at the first time and the first price defined in time-based pricing information 420, to UE 110 when UE 110 requests data 430 at the first time. Application server 130 may provide data 440, at the second time and the second price defined in time-based pricing information 420, to UE 110 when UE 110 requests data 440 at the second time. Data 430 may or may not be the same as data 440.

In one example, if a user of UE 110 wants to watch a live video during peak hours (e.g., the first time), application server 130 may warn the user that a higher price will be charged (e.g., the first price) since it is peak hours, and may ask the user if they are willing to pay the higher price. For example, application server 130 may instruct UE 110 to display a warning (e.g., “Due to high bandwidth demand at this time, you will be charged an additional $5.00 for watching this show, okay?”) to the user. If the user chooses to continue, application server 130 may provide the live video to UE 110 and may charge the user's account the higher price (e.g., the first price). Alternatively, or additionally, application server 130 may automatically download a large data file during off-peak hours to avoid the higher peak hour data pricing. For example, application server 130 may wait to download the large data file until the data pricing is low, such as at night (e.g., from 11:00 PM to 5:00 AM) or when a WiFi network is available in the user's home.

Although FIG. 4 shows example components of network portion 400, in other implementations, network portion 400 may include fewer components, different components, differently arranged components, or additional components than depicted in FIG. 4. Alternatively, or additionally, one or more components of network portion 400 may perform one or more other tasks described as being performed by one or more other components of network portion 400.

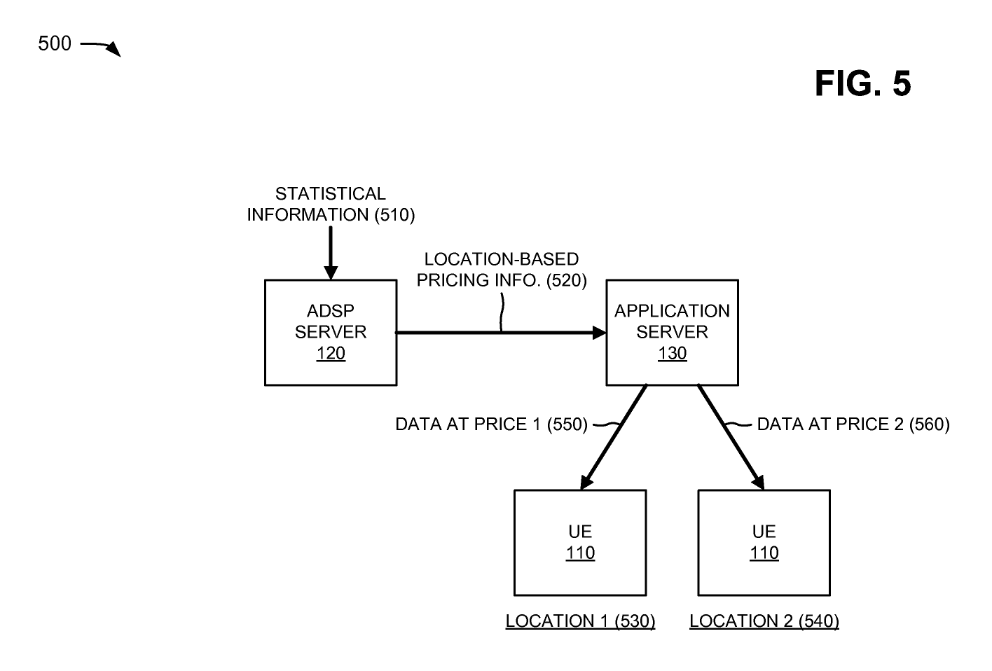

FIG. 5 is a diagram of example location-based pricing operations capable of being performed by an example portion 500 of network 100 (FIG. 1). As shown in FIG. 5, network portion 500 may include two UEs 110, ADSP server 120, and application server 130. UEs 110, ADSP server 120, and application server 130 may include the features described above in connection with one or more of, for example, FIGS. 1-4.

As further shown in FIG. 5, ADSP server 120 may receive statistical information 510, which may include data usage demands by UEs 110 and/or application servers 130 based on historical locations (e.g., cell site IDs) associated with UEs 110. ADSP server 120 may determine location-based pricing information 520 based on the data usage demands provided in statistical information 510. Location-based pricing information 520 may enable ADSP server 120 to control data usage by UEs 110 and application server 130 so that traffic may not exceed bandwidth limits provided at different locations. For example, location-based pricing information 520 may indicate that a first price (e.g., PRICE 1) should be charged when UE 110 is located at a first location 530 (e.g., LOCATION 1). In one example, first location 530 may be a location associated with peak data usage (e.g., a metropolitan area), and the first price may be a price (e.g., $0.5/kb) that is high enough to discourage users from accessing applications (e.g., downloading large files or watching a movie) from application server 130 when UE 110 is located at first location 530.

Alternatively, or additionally, location-based pricing information 520 may indicate that a second price (e.g., PRICE 2) should be charged when UE 110 is located at a second location 540 (e.g., LOCATION 2). In one example, second location 540 may be a location associated with off-peak data usage (e.g., a non-metropolitan area), and the second price may be a price (e.g., $0.2/kb) that is low enough to encourage users to access applications (e.g., downloading large files or watching a movie) from application server 130 when UE 110 is located at second location 540.

As further shown in FIG. 5, ADSP server 120 may provide location-based pricing information 520 to application server 130 in real time, and application server 130 may adjust data usage rates charged to users of UEs 110 in real time. Application server 130 may provide data 550, at the first price defined in location-based pricing information 520, to UE 110 when UE 110 requests data 550 at first location 530. Application server 130 may provide data 560, at the second price defined in location-based pricing information 520, to UE 110 when UE 110 requests data 560 at second location 540. Data 550 may or may not be the same as data 560.

In one example, if a user of UE 110 wants to watch a movie when UE 110 is at first location 530, application server 130 may warn the user that a higher price will be charged (e.g., the first price) since UE is at first location 530, and may ask the user if they are willing to pay the higher price. If the user chooses to continue, application server 130 may provide the movie to UE 110 and may charge the user's account the higher price (e.g., the first price). Alternatively, or additionally, application server 130 may wait to download a large data file, until UE 110 is located at second location 540, to avoid the higher peak hour data pricing. For example, application server 130 may wait to download the large data file until the data pricing is low, such as when UE 110 is connected to a WiFi network.

Although FIG. 5 shows example components of network portion 500, in other implementations, network portion 500 may include fewer components, different components, differently arranged components, or additional components than depicted in FIG. 5. Alternatively, or additionally, one or more components of network portion 500 may perform one or more other tasks described as being performed by one or more other components of network portion 500.

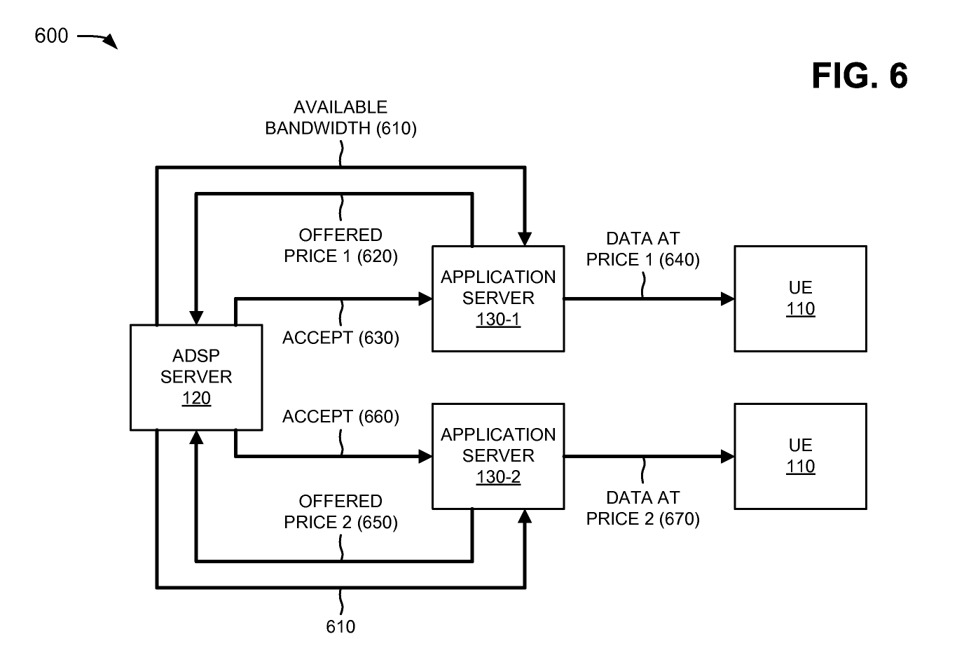

FIG. 6 is a diagram of example auction-based pricing operations capable of being performed by an example portion 600 of network 100 (FIG. 1). As shown in FIG. 6, network portion 600 may include two UEs 110, ADSP server 120, and two application servers 130 (labeled as application server 130-1 and 130-2). UEs 110, ADSP server 120, and application servers 130 may include the features described above in connection with one or more of, for example, FIGS. 1-5.

In one example implementation, ADSP server 120 may limit or control data usage in network 100 (FIG. 1) by dynamically auctioning available bandwidth to application servers 130 for a specific time period (e.g., one or more hours, one or more days, one or more weeks, etc.). Application servers 130 may communicate with ADSP server 120 to reserve bandwidth in advance through an auction method. The auction may be provided by ADSP server 120 to application servers 130 on an hourly, a daily, a weekly, a monthly, etc. basis so that application servers 130 may reserve bandwidth in advance.

For example, as shown in FIG. 6, ADSP server 120 may provide, to application server 130-1, an indication 610 of a bandwidth available in network 100, or, alternatively, application server 130-1 may request the available bandwidth. Application server 130-1 may provide a first offered price 620 (e.g., PRICE 1) for the available bandwidth to ADSP server 120, and ADSP server 120 may receive first offered price 620. ADSP server 120 may determine whether first offered price 620 is acceptable or fair for the available bandwidth. In one example, ADSP server 120 may make this determination by comparing first offered price 620 with rates charged for bandwidth comparable to the available bandwidth. If ADSP server 120 determines that first offered price 620 is unacceptable, ADSP server 120 and application server 130-1 may negotiate a different price. If ADSP server 120 determines that first offered price 620 is acceptable, ADSP server 120 may accept first offered price 620, as indicated by reference number 630, and may reserve the available bandwidth for application server 130-1 at first offered price 620. Application server 130-1 may provide data 640, at first offered price 620 and utilizing the available bandwidth, to UE 110 when UE 110 requests data 640. For example, during a special event or a sporting event, application server 130-1 may provide an additional charge to a user of UE 110 for viewing the special event/sporting event due to a higher data usage rate.

As further shown in FIG. 6, ADSP server 120 may provide, to application server 130-2, indication 610 of the bandwidth available in network 100, or, alternatively, application server 130-1 may request the available bandwidth. Application server 130-2 may provide a second offered price 650 (e.g., PRICE 2) for the available bandwidth to ADSP server 120, and ADSP server 120 may receive second offered price 650. ADSP server 120 may determine whether second offered price 650 is acceptable or fair for the available bandwidth. If ADSP server 120 determines that second offered price 650 is unacceptable, ADSP server 120 and application server 130-2 may negotiate a different price. If ADSP server 120 determines that second offered price 650 is acceptable, ADSP server 120 may accept second offered price 650, as indicated by reference number 660, and may reserve the available bandwidth for application server 130-2 at second offered price 650. Application server 130-2 may provide data 670, at second offered price 650 and utilizing the available bandwidth, to UE 110 when UE 110 requests data 670.

Alternatively, or additionally, ADSP server 120 may determine whether first offered price 620 is higher than second offered price 650. If ADSP server 120 determines that first offered price 620 is acceptable and higher than second offered price 650, ADSP server 120 may accept first offered price 620, and may reserve the available bandwidth for application server 130-1 (e.g., rather than application server 130-2) at first offered price 620. If ADSP server 120 determines that second offered price 650 is acceptable and higher than first offered price 620, ADSP server 120 may accept second offered price 650, and may reserve the available bandwidth for application server 130-2 (e.g., rather than application server 130-1) at second offered price 650.

In one example implementation, ADSP server 120 may base the auction on several parameters (e.g., besides a billing rate), such as dynamically defined parameters, time of use of the available bandwidth, etc., in order to maximize a total return. For example, application server 130-1 may attempt to reserve the available bandwidth for two hours at a price of $1.00/kb, and application server 130-2 may attempt to reserve the available bandwidth for eight hours at a price of $0.5/kb. In such a scenario, ADSP server 120 may determine that a total return for application server 130-2 is higher than a total return for application server 130-1, and may reserve the available bandwidth for application server 130-2 rather than application server 130-1.

Although FIG. 6 shows example components of network portion 600, in other implementations, network portion 600 may include fewer components, different components, differently arranged components, or additional components than depicted in FIG. 6. Alternatively, or additionally, one or more components of network portion 600 may perform one or more other tasks described as being performed by one or more other components of network portion 600.

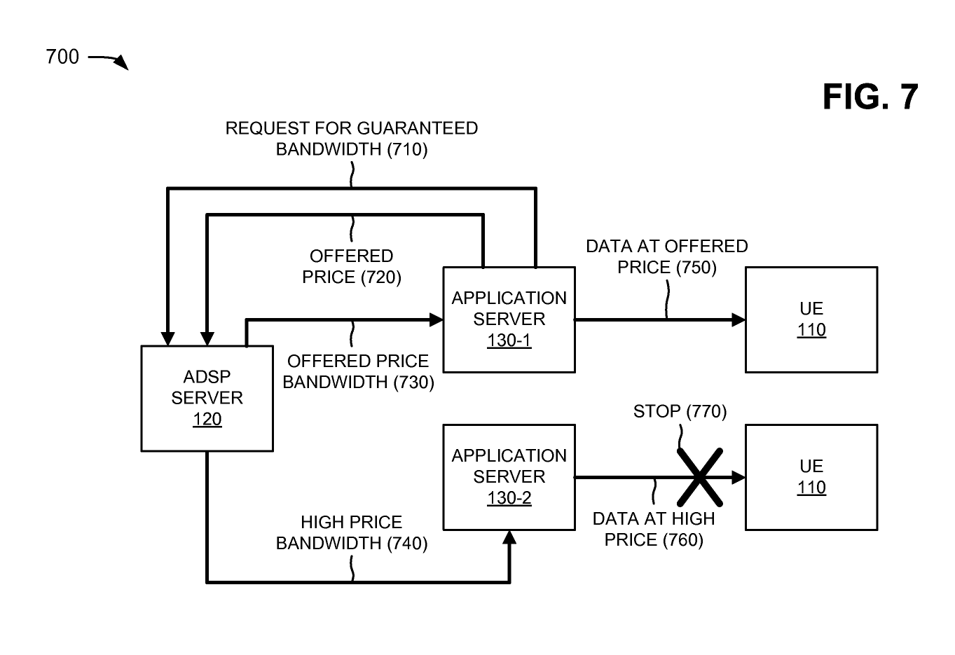

FIG. 7 is a diagram of example guaranteed bandwidth operations capable of being performed by an example portion 700 of network 100 (FIG. 1). As shown in FIG. 7, network portion 700 may include two UEs 110, ADSP server 120, and two application servers 130-1 and 130-2. UEs 110, ADSP server 120, and application servers 130 may include the features described above in connection with one or more of, for example, FIGS. 1-6.

ADSP server 120 may provide an extension to the auction-based pricing described above in connection with FIG. 6. For example, ADSP 120 may provide a guaranteed bandwidth to one or more application servers 130 willing to pay a highest price (e.g., via an auction). The guaranteed bandwidth may be allocated by ADSP server 120, for example, for unicast traffic, multicast traffic (e.g., mobile broadcasting multimedia service (MBMS) traffic), etc.

As shown in FIG. 7, application server 130-1 may provide a request 710 for guaranteed bandwidth to ADSP server 120, and ADSP server 120 may receive request 710. For example, application server 130-1 may request the guaranteed bandwidth in order to broadcast a special event, an important speech, etc. to UEs 110 via a broadcasting station. Application server 130-1 may provide an offered price 720 (e.g., PRICE) for the guaranteed bandwidth to ADSP server 120, and ADSP server 120 may receive offered price 720. ADSP server 120 may determine whether offered price 720 is acceptable or fair for the guaranteed bandwidth. In one example, ADSP server 120 may determine that offered price 720 is acceptable when offered price 720 is higher than any other price offered for the bandwidth. If ADSP server 120 determines that offered price 720 is unacceptable, ADSP server 120 and application server 130-1 may negotiate a different price. If ADSP server 120 determines that offered price 720 is acceptable, ADSP server 120 may accept offered price 720, and may reserve the guaranteed bandwidth for application server 130-1 at offered price 720, as indicated by reference number 730.

In order to guarantee the bandwidth to application server 130-1 when network traffic increases to a bandwidth limit of network 100 (FIG. 1), ADSP server 120 may dynamically raise a price charged to other application servers 130 for network bandwidth. For example, as shown in FIG. 7, ADSP server 120 may dynamically raise the price charged to application server 130-2 for network bandwidth, as indicated by reference number 740. By raising the price charged for bandwidth to other application servers 130, data usage by the other application servers 130 may be lowered and bandwidth may be guaranteed for application server 130-1. For example, if offered price 720 is set at $0.5/kb for application server 130-1, ADSP server 120 may set a price charged for bandwidth to other application servers 130 at an extremely high rate (e.g., $10.00/kb). The extremely high rate may effectively inform the other application servers 130 to cease data usage, and may enable ADSP server 120 to prevent network overload and to guarantee bandwidth to application server 130-1.

As further shown in FIG. 7, application server 130-1 may provide data 750, at offered price 720 and utilizing the guaranteed bandwidth, to UE 110 when UE 110 requests data 750. Application server 130-2 may provide data 760 (e.g., at a reasonable price) to UE 110 when UE 110 requests data 760 and when the bandwidth limit for network 100 is not reached. However, when the bandwidth limit of network is close to being reached, application server 130-2 may provide data 760, at the extremely high rate, to UE 110 when UE 110 requests data 760. The extremely high rate associated with data 760 may cause UE 110 to stop receiving data 760, as indicated by reference number 770, and may effectively preserve the guaranteed bandwidth for application server 130-1.

Although FIG. 7 shows example components of network portion 700, in other implementations, network portion 700 may include fewer components, different components, differently arranged components, or additional components than depicted in FIG. 7. Alternatively, or additionally, one or more components of network portion 700 may perform one or more other tasks described as being performed by one or more other components of network portion 700.

In one example implementation, ADSP server 120 may utilize one or more of the pricing mechanisms, described above, at the same time or at different times. For example, ADSP server 120 may utilize one or more of the time-based pricing mechanism (FIG. 4), the location-based pricing mechanism (FIG. 5), the auction-based pricing mechanism (FIG. 6), and/or the guaranteed bandwidth-based pricing mechanism (FIG. 7) at the same time or at different times.

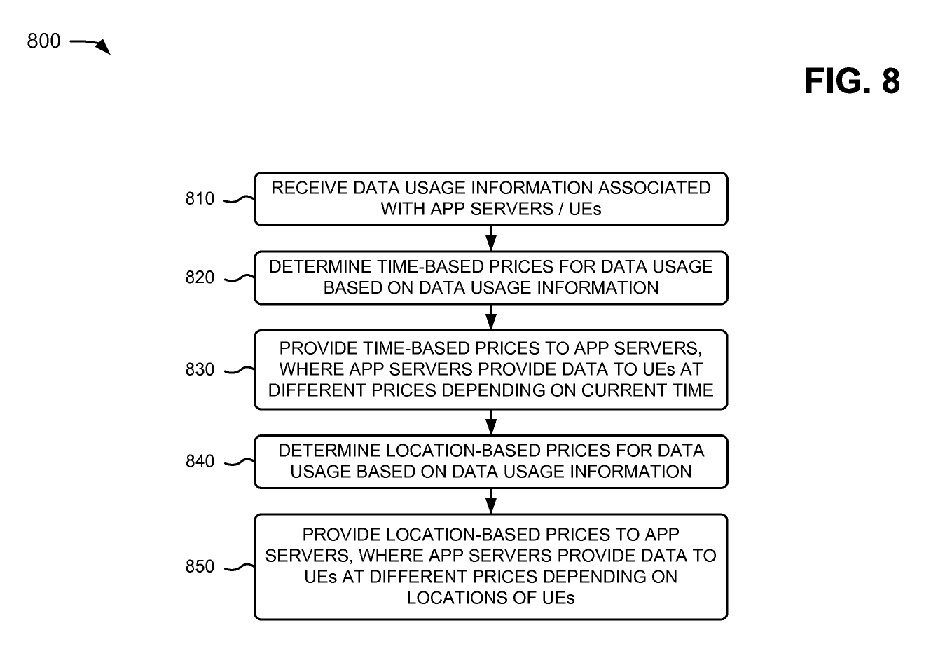

FIG. 8 is a flow chart of an example process 800 for providing time-based and location-based pricing for network bandwidth according to an implementation described herein. In one implementation, process 800 may be performed by ADSP server 120. Alternatively, or additionally, some or all of process 800 may be performed by another device or group of devices, including or excluding ADSP server 120.

As shown in FIG. 8, process 800 may include receiving data usage information associated with application servers and/or UEs (block 810), and determining time-based prices for data usage based on the data usage information (block 820). For example, in an implementation described above in connection with FIG. 4, ADSP server 120 may receive statistical information 410, which may include data usage demands by UEs 110 and/or application servers 130 on an hourly basis, a daily basis, a weekly basis, etc. ADSP server 120 may determine time-based pricing information 420 based on the data usage demands provided in statistical information 410. Time-based pricing information 420 may enable ADSP server 120 to control data usage by UEs 110 and application server 130. In one example, time-based pricing information 420 may indicate that a first price (e.g., PRICE 1) should be charged during a first time of day (e.g., a time associated with peak data usage), and may indicate that a second price (e.g., PRICE 2) should be charged during a second time of day (e.g., a time associated with off-peak data usage).

As further shown in FIG. 8, process 800 may include providing the time-based prices to the application servers, where the application servers provide data to the UEs at different prices depending on a current time (block 830). For example, in an implementation described above in connection with FIG. 4, ADSP server 120 may provide time-based pricing information 420 to application server 130 in real time, and application server 130 may adjust data usage rates charged to users of UEs 110 in real time. Application server 130 may provide data 430, at the first time and the first price defined in time-based pricing information 420, to UE 110 when UE 110 requests data 430 at the first time. Application server 130 may provide data 440, at the second time and the second price defined in time-based pricing information 420, to UE 110 when UE 110 requests data 440 at the second time. Data 430 may or may not be the same as data 440.

Returning to FIG. 8, process 800 may include determining location-based prices for data usage based on the data usage information (block 840), and providing the location-based prices to the application servers, where the application servers provide data to the UEs at different prices depending on locations of the UEs (block 850). For example, in an implementation described above in connection with FIG. 5, ADSP server 120 may determine location-based pricing information 520 based on the data usage demands provided in statistical information 510. Location-based pricing information 520 may indicate that a first price should be charged when UE 110 is located at first location 530 (e.g., a location associated with peak data usage), and may indicate that a second price should be charged when UE 110 is located at second location 540 (e.g., a location associated with off-peak data usage). ADSP server 120 may provide location-based pricing information 520 to application server 130 in real time, and application server 130 may adjust data usage rates charged to users of UEs 110 in real time. Application server 130 may provide data 550, at the first price, to UE 110 when UE 110 requests data 550 at first location 530. Application server 130 may provide data 560, at the second price, to UE 110 when UE 110 requests data 560 at second location 540. Data 550 may or may not be the same as data 560. In one example implementation, the location-based pricing may be an adjustment to the time-based pricing, such as when one location has price inflation while another location has a price discount. For example, a time-based price (e.g., $×/kb) may be modified by location-based pricing information, such that in a discount location the time-based price may be modified to $0.5×/kb (i.e., a 50% discount) while in a higher price location the time-based price may be modified to $2×/kb (i.e., two times inflation).

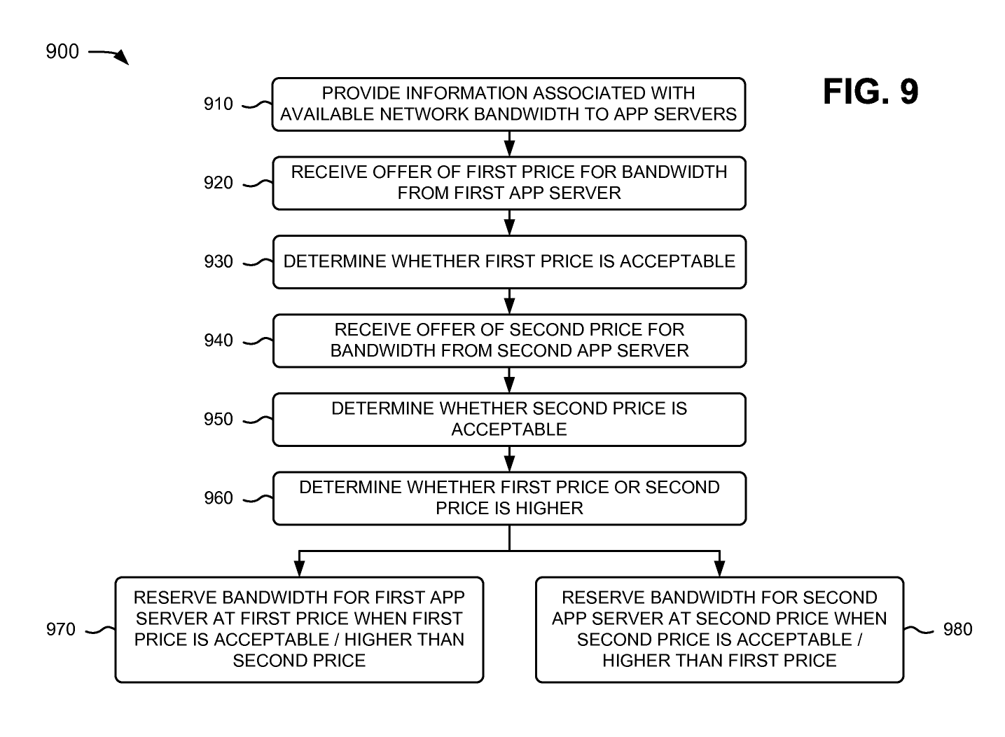

FIG. 9 is a flow chart of an example process 900 for providing auction-based pricing for network bandwidth according to an implementation described herein. In one implementation, process 900 may be performed by ADSP server 120. Alternatively, or additionally, some or all of process 900 may be performed by another device or group of devices, including or excluding ADSP server 120.

As shown in FIG. 9, process 900 may include providing information associated with available network bandwidth to application servers (block 910), receiving an offer a first price for the bandwidth from a first application server (block 920), and determining whether the first price is acceptable (block 930). For example, in an implementation described above in connection with FIG. 6, ADSP server 120 may provide, to application server 130-1, indication 610 of a bandwidth available in network 100, or, alternatively, application server 130-1 may request the available bandwidth. Application server 130-1 may provide first offered price 620 (e.g., PRICE 1) for the available bandwidth to ADSP server 120, and ADSP server 120 may receive first offered price 620. ADSP server 120 may determine whether first offered price 620 is acceptable or fair for the available bandwidth. In one example, ADSP server 120 may make this determination by comparing first offered price 620 with rates charged for bandwidth comparable to the available bandwidth.

As further shown in FIG. 9, process 900 may include receiving an offer of a second price for the bandwidth from a second application server (block 940), and determining whether the second price is acceptable (block 950). For example, in an implementation described above in connection with FIG. 6, application server 130-2 may provide second offered price 650 (e.g., PRICE 2) for the available bandwidth to ADSP server 120, and ADSP server 120 may receive second offered price 650. ADSP server 120 may determine whether second offered price 650 is acceptable or fair for the available bandwidth.

Returning to FIG. 9, process 900 may include determining whether the first price or the second price is higher (block 960), and reserving bandwidth for the first application server at the first price when the first price is acceptable and higher than the second price (block 970) or reserving bandwidth for the second application server at the second price when the second price is acceptable and higher than the first price (block 980). For example, in an implementation described above in connection with FIG. 6, ADSP server 120 may determine whether first offered price 620 is higher than second offered price 650. If ADSP server 120 determines that first offered price 620 is acceptable and higher than second offered price 650, ADSP server 120 may accept first offered price 620, and may reserve the available bandwidth for application server 130-1 (e.g., rather than application server 130-2) at first offered price 620. If ADSP server 120 determines that second offered price 650 is acceptable and higher than first offered price 620, ADSP server 120 may accept second offered price 650, and may reserve the available bandwidth for application server 130-2 (e.g., rather than application server 130-1) at second offered price 650.

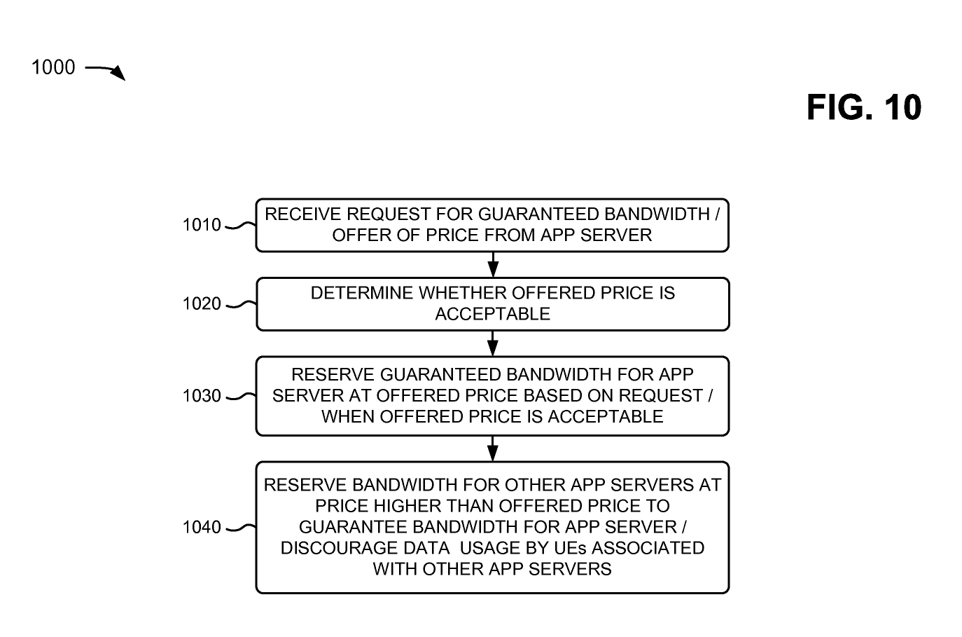

FIG. 10 is a flow chart of an example process for providing guaranteed network bandwidth according to an implementation described herein. In one implementation, process 1000 may be performed by ADSP server 120. Alternatively, or additionally, some or all of process 1000 may be performed by another device or group of devices, including or excluding ADSP server 120.

As shown in FIG. 10, process 1000 may include receiving a request for a guaranteed bandwidth and an offer of a price for the guaranteed bandwidth from an application server (block 1010), and determining whether the offered price is acceptable (block 1020). For example, in an implementation described above in connection with FIG. 7, application server 130-1 may provide request 710 for guaranteed bandwidth to ADSP server 120, and ADSP server 120 may receive request 710. In one example, application server 130-1 may request the guaranteed bandwidth in order to broadcast a special event, an important speech, etc. to UEs 110 via a broadcasting station. Application server 130-1 may provide offered price 720 for the guaranteed bandwidth to ADSP server 120, and ADSP server 120 may receive offered price 720. ADSP server 120 may determine whether offered price 720 is acceptable or fair for the guaranteed bandwidth. In one example, ADSP server 120 may determine that offered price 720 is acceptable when offered price 720 is higher than any other price offered for the bandwidth.

As further shown in FIG. 10, process 1000 may include reserving the guaranteed bandwidth for the application server at the offered price, and based on the request, when the offered price is acceptable (block 1030). For example, in an implementation described above in connection with FIG. 7, If ADSP server 120 determines that offered price 720 is acceptable, ADSP server 120 may accept offered price 720, and may reserve the guaranteed bandwidth for application server 130-1 at offered price 720, as indicated by reference number 730.

Returning to FIG. 10, process 1000 may include reserving bandwidth for other application servers at a price higher than the offered price to guarantee the bandwidth for the application server and to discourage data usage by UEs associated with the other application servers (block 1040). For example, in an implementation described above in connection with FIG. 7, in order to guarantee the bandwidth to application server 130-1 when network traffic increases to a bandwidth limit of network 100, ADSP server 120 may dynamically raise a price charged to other application servers 130 for network bandwidth. In one example, ADSP server 120 may dynamically raise the price charged to application server 130-2 for network bandwidth, as indicated by reference number 740. By raising the price charged for bandwidth to other application servers 130, data usage by the other application servers 130 may be lowered and bandwidth may be guaranteed for application server 130-1.

Systems and/or methods described herein may enable a service provider to monitor and meter data service provided by application servers to UEs. The systems and/or methods may enable the service provider to control traffic between the application servers and the UEs by dynamically changing a price charged for data usage by the application servers. In one example, the systems and/or methods may enable the service provider to provide time-based dynamic pricing, location-based dynamic pricing, auction-based dynamic pricing, and/or a guaranteed bandwidth to the application servers. The data usage prices may be charged to the application servers rather than to the users of the UEs.

The foregoing description of implementations provides illustration and description, but is not intended to be exhaustive or to limit the invention to the precise form disclosed. Modifications and variations are possible in light of the above teachings or may be acquired from practice of the invention.

For example, while series of blocks have been described with regard to FIGS. 8-10, the order of the blocks may be modified in other implementations. Further, non-dependent blocks may be performed in parallel.

It will be apparent that example aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

Even though particular combinations of features are recited in the claims and/or disclosed in the specification, these combinations are not intended to limit the disclosure of the invention. In fact, many of these features may be combined in ways not specifically recited in the claims and/or disclosed in the specification. Although each dependent claim listed below may directly depend on only one other claim, the disclosure of the invention includes each dependent claim in combination with every other claim in the claim set.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

1. A method, comprising:
receiving, by a device, data usage information associated with application server devices and user equipment, wherein the data usage information identifies data usage demands by the user equipment and the application server devices corresponding to locations associated with the user equipment;
determining, by the device, time-based and location-based pricing for data usage based on the data usage information with respect to bandwidth limits associated with different ones of the locations, wherein the time-based and location-based pricing includes at least:
a first price for data usage in a first one of the locations determined to correspond to a peak data usage, and
a second price, less than the first price, for data usage in a second one of the locations determined to correspond to a non-peak data usage; and
providing, by the device, the first and second prices for data usage to the application server devices,
wherein different ones of the application server devices are charged for data usage, between the application server devices and the user equipment located at the first location and between the application server devices and the user equipment located at the second location, according to the first price or the second price, respectively.

2. The method of claim 1, wherein the data usage information further identities:
data usage demands by the user equipment and the application server devices based on a particular time period.

3. (canceled)

4. (canceled)

5. The method of claim 1, where the device includes a data service platform server device.

6. The method of claim 1, wherein at least a portion of the data usage information is received from the user equipment and at least a portion of the data usage information is received from the application server devices.

7. A device, comprising:
a memory to store a plurality of instructions; and
a processor configured to execute instructions in the memory to:
receive data usage information associated with application server devices and user equipment, wherein the data usage information identifies data usage demands by the user equipment and the application server devices based on locations associated with the user equipment,
determine time-based and location-based pricing for data usage based on the data usage information with respect to bandwidth limits associated with different ones of the locations, wherein the time-based and location-based pricing includes at least:
a first price for data usage in a first one of the locations determined to correspond to a peak price location, and
a second price, less than the first price, for data usage in a second one of the locations determined to correspond to a non-peak price location, and
provide the first and second prices for data usage to the application server devices, wherein different ones of the application server devices provide data to the user equipment at the first price or the second price depending on a particular location of the user equipment.

8. (canceled)

9. The device of claim 7, wherein the data usage information further includes:
data usage demands by the user equipment and the application server devices based on a particular time period.

10. (canceled)

11. The device of claim 7, wherein the processor is further configured to execute instructions in the memory to charge the first and second prices to the different application servers.

12. The device of claim 7, wherein at least a portion of the data usage information is received from the user equipment and at least a portion of the data usage information is received from the application server devices.

13-21. (canceled)

22. The method of claim 6, wherein the at least a portion of the data usage information received from the application server devices comprises a data table including:
a time field, a cell site ID field, an application ID field, a source IP field, a source port field, a data call type field, a usage field, a bill code field, and a billing, rate field.

23. The method of claim 22, further comprising:
determining, based on entries in the cell site ID field, the locations associated with the user equipment.

24. The device of claim 12, wherein the at least a portion of the data usage information received from the application server devices comprises a data table including:
a time field, a cell site ID field, an application ID field, a source IP field, a source port field, a data call type field, a usage field, a bill code field, and a billing rate field.

25. The method of claim 24, wherein the processor is further configured to execute instructions in the memory to:
determine, based on entries in the cell site ID field, the locations associated with the user equipment.

26. A non-transitory computer-readable medium comprising instructions executable by at least one processor, the instructions to cause the at least one processor to:
receive data usage information associated with application server devices and user equipment, wherein the data usage information identifies data usage demands by the user equipment and the application server devices based on historical locations associated with the user equipment,
determine time-based and location-based pricing for data usage based on the data usage information with respect to bandwidth limits associated with different ones of the historical locations, wherein the time-based and location-based pricing includes at least:
a first price for data usage in a first one of the historical locations, and
a second price, less than the first price, for data usage in a second one of the historical locations, and
provide the first and second prices for data usage to the application server devices, wherein different ones of the application server devices provide data to the user equipment at the first price or the second price depending on a particular historical location of the user equipment.

27. The non-transitory computer-readable medium of claim 26, wherein the data usage information further identifies:
data usage demands by the user equipment and the application server devices based on a particular time period.

28. The non-transitory computer-readable medium of claim 26, wherein the instructions further cause the at least one processor to:
charge the first and second prices to the different application servers.

29. The non-transitory computer-readable medium of claim 26, wherein the instructions further cause the at least one processor to:
receive at least a portion of the data usage information from the user equipment, and
receive at least a portion of the data usage information from the application server devices.

30. The non-transitory computer-readable medium of claim 29, wherein the at least a portion of the data usage information received from the application server devices comprises a data table including:
a time field, a cell site 11) field, an application II) field, a source IP field, a source port field, a data call type field, a usage field, a bill code field, and a billing rate field.

31. The non-transitory computer-readable medium of claim 30, wherein the instructions further cause the at least one processor to:
determine, based on entries in the cell site ID field, the historical locations associated with the user equipment.
